(19) United States
(12) Patent Application Publication
(10) Pub. No.: US 2012/0142414 A1
(43) Pub. Date: Jun. 7, 2012

(54) INFORMATION PROCESSING DEVICE, METHOD OF CONTROLLING AN INFORMATION PROCESSING DEVICE, AND NON-TRANSITORY INFORMATION STORAGE MEDIUM

(75) Inventor: Junichi MURAKAMI, Chiba (JP)

(73) Assignee: KONAMI DIGITAL ENTERTAINMENT CO., LTD., Tokyo (JP)

(21) Appl. No.: 13/307,660

(22) Filed: Nov. 30, 2011

(30) Foreign Application Priority Data
Dec. 1, 2010 (JP) 2010-268573

(51) Int. Cl. G06T 15/00; A63F 13/00

(52) U.S. Cl. 463/32; 345/419

(57) ABSTRACT

An information processing device, which displays an image on a display screen based on a viewing field set in a two-dimensional image or a virtual three-dimensional space, includes: a contact point information obtaining unit for obtaining contact point information which indicates a point of contact with the display screen; a first display control unit for displaying the image on the display screen by moving the viewing field in a reference direction in a case where a contact point shift direction corresponds to the reference direction; and a second display control unit for displaying the image on the display screen after the contact with the display screen is broken off, by setting a position of the viewing field based on the contact point shift direction that is observed prior to the breaking off of the contact.

### CROSS-REFERENCE TO RELATED APPLICATION

The present application claims priority from Japanese application JP 2010-268573 filed on Dec. 1, 2010, the content of which is hereby incorporated by reference into this application.

### BACKGROUND OF THE INVENTION

1. Field of the Invention

The present invention relates to an information processing device, a method of controlling an information processing device, and a non-transitory information storage medium.

2. Description of the Related Art

There have been known information processing devices that display an image on a display screen based on a viewing field set in a two-dimensional image or in a virtual three-dimensional space. JP 2007-160017 A, for example, describes a technology for scrolling over an image by moving the viewing field in accordance with a user's operation.

### SUMMARY OF THE INVENTION

With the technology of JP 2007-160017A, in a case where the user stops operating, the viewing field does not move. To move the viewing field to another spot, the user needs to newly make an operation. A possible alternative is to automatically move the viewing field to a predetermined point in a case where the user stops operating. However, there are cases where holding the viewing field to the current spot, or automatically moving the viewing field to another spot, is preferred to moving the viewing field to a predetermined spot, and this method does not improve the user-friendliness in such cases.

The present invention has been made in view of the problem described above, and an object of the present invention is therefore to provide an information processing device improved in user-friendliness, a method of controlling an information processing device, and a non-transitory information storage medium.

In order to solve the problem described above, according to the present invention, there is provided an information processing device, which displays an image on a display screen based on a viewing field set in a two-dimensional image or a virtual three-dimensional space, including: contact point information obtaining means for obtaining contact point information which indicates a point of contact with the display screen; first display control means for displaying the image on the display screen by moving the viewing field in a reference direction in a case where a contact point shift direction corresponds to the reference direction; and second display control means for displaying the image on the display screen after the contact with the display screen is broken off, by setting a position of the viewing field based on the contact point shift direction that is observed prior to the breaking off of the contact.

According to the present invention, there is also provided a method of controlling an information processing device, which displays an image on a display screen based on a viewing field set in a two-dimensional image or a virtual three-dimensional space, including: a contact point information obtaining step of obtaining contact point information which indicates a point of contact with the display screen; a first display control step of displaying the image on the display screen by moving the viewing field in a reference direction in a case where a contact point shift direction corresponds to the reference direction; and a second display control step of displaying the image on the display screen after the contact with the display screen is broken off, by setting a position of the viewing field based on the contact point shift direction that is observed prior to the breaking off of the contact.

According to the present invention, there is also provided a program for causing a computer to function as an information processing device, which displays an image on a display screen based on a viewing field set in a two-dimensional image or a virtual three-dimensional space, the information processing device including: contact point information obtaining means for obtaining contact point information which indicates a point of contact with the display screen; first display control means for displaying the image on the display screen by moving the viewing field in a reference direction in a case where a contact point shift direction corresponds to the reference direction; and second display control means for displaying the image on the display screen after the contact with the display screen is broken off, by setting a position of the viewing field based on the contact point shift direction that is observed prior to the breaking off of the contact.

According to the present invention, there is also provided a non-transitory computer readable information storage medium having recorded thereon the above-mentioned program.

According to the present invention, it is possible to improve user-friendliness.

Further, according to an aspect of the present invention, the second display control means is configured to: in a case where the contact point shift direction prior to the breaking off of the contact corresponds to the reference direction, move the viewing field to an initial point, which is where the moving of the viewing field by the first display control means starts; and in a case where the contact point shift direction prior to the breaking off of the contact does not correspond to the reference direction, restrict the move of the viewing field to the initial point.

Further, according to an aspect of the present invention, the two-dimensional image or the virtual three-dimensional space includes a plurality of reference points which are defined in advance, and the second display control means is configured to: in a case where the contact point shift direction prior to the breaking off of the contact correspond to the reference direction, move the viewing field based on a positional relation between the position of the viewing field prior to the breaking off of the contact and the plurality of reference points; and in a case where the contact point shift direction prior to the breaking off of the contact does not correspond to the reference direction, restrict the move of the viewing field based on the positional relation.

Further, according to an aspect of the present invention, the information processing device further includes means for scrolling the display screen based on the move of the viewing field, and the second display control means includes means for determining a scroll speed of the display screen based on at least one of the contact point shift direction and shift amount prior to the breaking off of the contact.

Further, according to an aspect of the present invention, the information processing device further includes: means for running a game; and means for obtaining game situation data which indicates the situation of the game, and the second display control means sets the position of the viewing field after the contact with the display screen is broken off, based on the contact point shift direction prior to the breaking off of the contact and on the game situation data.

### BRIEF DESCRIPTION OF THE DRAWINGS

In the accompanying drawings:

FIG. 1 is a perspective view illustrating a frontal view of a game machine;

FIG. 2 is a diagram illustrating the hardware configuration of the game machine;

FIG. 3 is a diagram illustrating a method of generating a game screen;

FIG. 4 is a diagram illustrating game screens that are displayed on a first liquid crystal display unit and a second liquid crystal display unit;

FIG. 5 is a diagram illustrating a screen transition that is executed when a viewing field image is touched to be slid to the left or the right and then released;

FIG. 6 is a diagram illustrating a screen transition that is executed when a user touches the viewing field image to slide the viewing field image to the left or the right and to subsequently slide the viewing field image by a given amount in a direction that is downward from the user's viewpoint, and then releases hold of the viewing field image;

FIG. 7 is a diagram illustrating a screen transition that is executed when the user touches the viewing field image to slide the viewing field image to the left or the right and to subsequently slide the viewing field image by a given amount in a direction that is upward from the user's viewpoint, and then releases hold of the viewing field image;

FIG. 8 is a functional block diagram illustrating functions that are relevant to the present invention out of functions implemented in the game machine;

FIG. 9 is a diagram illustrating the association between a contact point shift direction before the contact is broken off and information about a destination of the viewing field;

FIG. 10 is a flow chart illustrating processing that is executed by the game machine after a game is started;

FIG. 11 is a diagram illustrating a game space in Modification Example (1);

FIG. 12 is a diagram illustrating reference points in Modification Example (2);

FIG. 13 is a diagram illustrating the relation between the position of a representative vertex of the viewing field at the time the contact is broken off and a destination point of the viewing field; and

FIG. 14 is a diagram illustrating the relation between a contact point shift direction and/or shift amount before the contact is broken off and a viewing field moving speed.

### DETAILED DESCRIPTION OF THE INVENTION

### [1. Embodiments]

Hereinafter, detailed description is given of an example of an embodiment of the present invention based on the drawings. Herein, description is given of a case where an information processing device according to the embodiment of the present invention is implemented by a portable game machine. Note that the information processing device according to the embodiment of the present invention may be implemented by a mobile phone, a personal digital assistant (PDA), a laptop computer, or the like.

### [2. External Appearance of Game Machine]

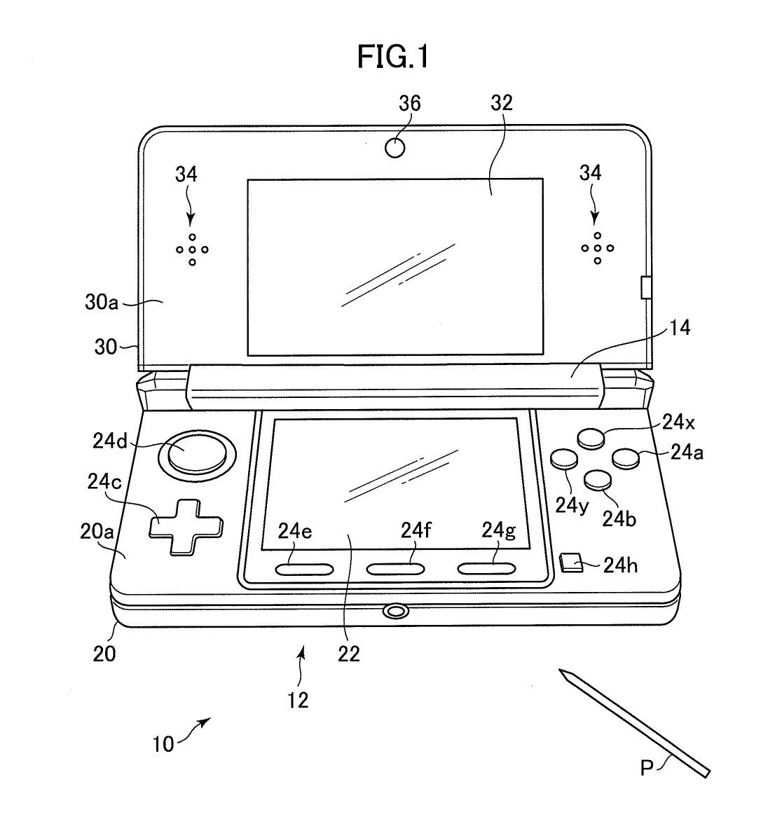

FIG. 1 is a perspective view illustrating the game machine 10 as viewed from the front. As illustrated in FIG. 1, the game machine 10 includes a first casing 20 and a second casing 30. The first casing 20 and the second casing 30 are coupled together by a hinge unit 14.

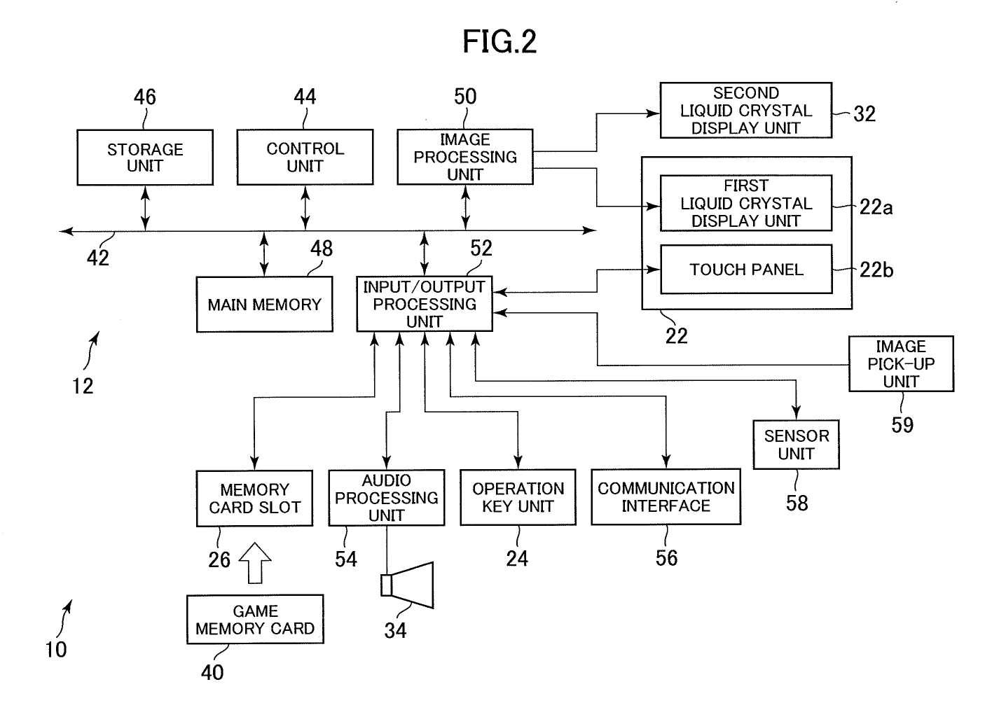

A touch screen 22, a cross-shaped button 24c, a slide pad 24d, buttons 24a, 24b, 24x, 24y, 24e, 24f, 24g, and a power button 24h are provided on a top surface 20a of the first casing 20. The touch screen 22 includes a first liquid crystal display unit 22a and a touch panel 22b (see FIG. 2). The touch panel 22b is placed over the first liquid crystal display unit 22a.

A user uses a touch pen P or the like to touch a given point on the touch screen 22 (i.e., the touch panel 22b) to operate the game machine 10. For example, the user grips the touch pen P in one hand and holds the first casing 20 or the second casing 30 with the other hand to play a game. The user operates the game machine 10 by touching a given point on the touch screen 22 with the touch pen P and sliding (dragging) the touch pen P to another point while maintaining the contact.

The cross-shaped button 24c and the slide pad 24d are used, for example, for direction instructing operations. The cross-shaped button 24c, the slide pad 24d, and the buttons 24a, 24b, 24x, 24y, 24e, 24f, and 24g are used for various operations in the same manner as the touch pen P is used in the operation described above. The power button 24h is used to instruct a not-shown battery to supply power to the components of the game machine 10.

A second liquid crystal display unit 32 is provided on a surface 30a of the second casing 30. The second liquid crystal display unit 32 maybe equipped with an unaided stereo vision function, for example. The second casing 30 has speakers 34 and a front-facing camera 36 as built-in components.

### [3. Hardware Construction of Game Machine]

FIG. 2 is a diagram illustrating a hardware configuration of the game machine 10 according to the embodiment of the present invention. As illustrated in FIG. 2, the game machine 10 includes a touch screen 22 (first liquid crystal display unit 22a and touch panel 22b), an operation key unit 24, a memory card slot 26, the second liquid crystal display unit 32, the speaker 34, a bus 42, a control unit 44, a storage unit 46, a main memory 48, an image processing unit 50, an input/output processing unit 52, an audio processing unit 54, and a communication interface 56.

The control unit 44 controls the components of the game machine 10 based on an operating system which is stored in the storage unit 46, and on a program and various types of data which are stored in a game memory card 40.

The storage unit 46 is composed to include a non-volatile storage medium such as a flash memory. The storage unit 46 stores an operating system and others.

The main memory 48 is composed to include, for example, a RAM. A program read out of the game memory card 40 via the memory card slot 26 is written into the main memory 48 as the need arises. The main memory 48 is also used as a work memory of the control unit 44.

The bus 42 is used to exchange addresses and various types of data between components of the game machine 10. The control unit 44, the main memory 48, the image processing unit 50, and the input/output processing unit 52 are connected to one another by the bus 42 in a manner that allows these components to communicate data with one another.

The touch screen 22 and the second liquid crystal display unit 32 are known display screens (for example, liquid crystal display panels). This embodiment describes a case in which the game machine 10 includes two display screens: the touch screen 22 and the second liquid crystal display unit 32.

The image processing unit 50 includes a VRAM. The image processing unit 50 renders an image in the VRAM according to an instruction from the control unit 44. The image rendered in the VRAM is displayed on the first liquid crystal display unit 22a and second liquid crystal display unit 32 at a predetermined timing.

The input/output processing unit 52 is an interface by which the control unit 44 exchanges each piece of data with the touch panel 22b, the operation key unit 24, the memory card slot 26, the audio processing unit 54, the communication interface 56, a sensor unit 58, and an image pickup unit 59. The input/output processing unit 52 is connected with the touch panel 22b, the operation key unit 24, the memory card slot 26, the audio processing unit 54, the communication interface 56, the sensor unit 58, and the image pickup unit 59.

The operation key unit 24 is input means by which the user makes an operation input. The operation key unit 24 includes the cross-shaped button 24c, slide pad 24d, the buttons 24a, 24b, 24x, 24y, 24e, 24f, 24g, and the power button 24h. The input/output processing unit 52 scans the state of each part of the operation key unit 24 every predetermined cycle (e.g., every 1/60^{th} of a second), and supplies an operation signal representing the scanning result to the control unit 44 via the bus 42. The control unit 44 determines specifics of the operation performed by the user, based on the operation signal.

The touch panel 22b functions as input means in the same manner as the operation key unit 24 by which the user makes an operation input. The touch panel 22b supplies contact point information corresponding to the position pressed by the user or by an object (touch pen P) that the user grasps to the control unit 44 via the input/output processing unit 52.

The contact point information is data that indicates, for example, the two-dimensional coordinates of a point at which the touch panel 22b is touched. The control unit 44 determines at which point the user has touched the touch panel 22b based on the contact point information.

In this embodiment, every set of two-dimensional coordinates indicated by the contact point information corresponds to the position of one of the pixels in the first liquid crystal display unit 22a. In a case where the first liquid crystal display unit 22a has a resolution of 320 pixels by 240 pixels, for example, two-dimensional coordinates indicated by the contact point information have a value between 1 and 320 as a horizontal coordinate and a value between 1 and 240 as a vertical coordinate.

The memory card slot 26 reads a game program and game data stored in the game memory card 40 according to an instruction from the control unit 44. The game memory card 40 includes a ROM where the game program and game data such as image data are stored, and an EEPROM where the game data, such as saved data, is stored.

It should be noted that this embodiment illustrates a case by an example in which the game memory card 40 is used to supply the game program and game data to the game machine 10, but another information storage medium, such as an optical disk, may be used as well. In addition, the game program and game data maybe supplied to the game machine 10 from a remote location over a communication network, such as the Internet. As another alternative, the game program and game data may be supplied to the game machine 10 using various kinds of data communications, such as infrared communication.

The audio processing unit 54 includes a sound buffer. The audio processing unit 54 outputs music or sound from the speaker 34 based on music output data or sound data which are stored in the sound buffer. The communication interface 56 is an interface for connecting the game machine 10 to the communication network.

The sensor unit 58 is composed to include a gyro sensor, a motion sensor, and the like, and detects the posture of the game machine 10. The image pick-up unit 59 is composed to include the front-facing camera 36, a not-shown back-facing camera, and others, and generates a picked-up image.

### [4. Screens Displayed by the Game Machine]

The game machine 10 runs a video game by executing a game program which is read out of the game memory card 40. This embodiment describes a case of running a video game in which a game character moving over a two-dimensional image aims to attack the territory of the opponent (for example, a lateral scroll game). The game run on the game machine 10 may be a game that uses a virtual three-dimensional space (details thereof are described in Modification Examples).

As the game begins to run, game screens are displayed on the first liquid crystal display unit 22a and the second liquid crystal display unit 32.

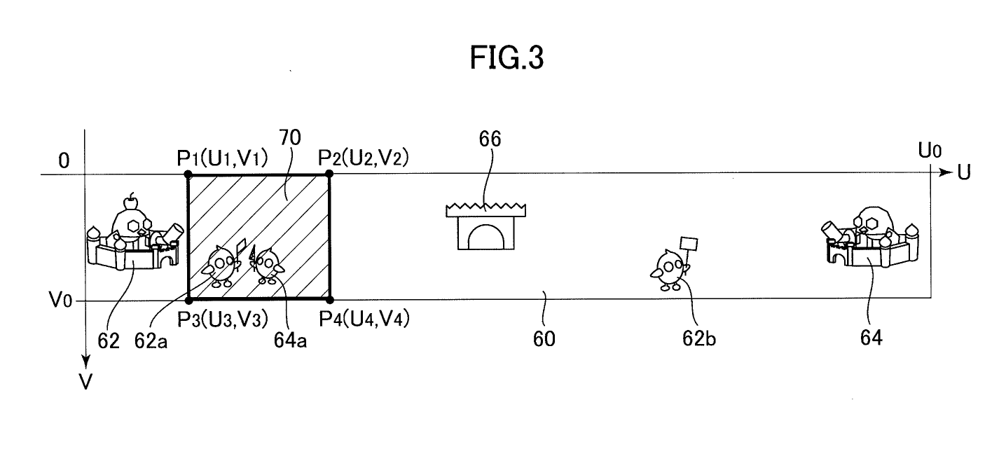

FIG. 3 is a diagram illustrating a method of generating a game screen. As illustrated in FIG. 3, a game screen is generated from a background image 60 (two-dimensional image) and object images used in the game (for example, an own territory 62, fellow characters 62a and 62b, an opponent territory 64, an opponent character 64a, and a fort 66).

Where an object image is displayed is specified by two-dimensional coordinates (for example, U-V coordinates) set on the background image 60. In this embodiment, a U-axis is set in the horizontal direction and a V-axis is set in the vertical direction with the upper left vertex of the background image 60 as an origin O. The background image 60 is defined as, for example, an area in which the U-coordinate takes a value from 0 to U₀ and the V-coordinate takes a value from 0 to V₀.

The fellow characters 62a and 62b and the opponent character 64a in this embodiment move over the background image 60 under control of the game program. In other words, two-dimensional coordinates representing the positions of the fellow characters 62a and 62b and the opponent character 64a are updated by the game program. The own territory 62, the opponent territory 64, and the fort 66 do not change their positions in this embodiment. Alternatively, the own territory 62, the opponent territory 64, and the fort 66 may be designed to change their positions.

Further, in this embodiment, a viewing field 70 having a rectangular shape is set to be overlaid on the background image 60. The viewing field 70 is a display target area for specifying which area is to be displayed on one display screen (for example, the first liquid crystal display unit 22a or the second liquid crystal display unit 32). Specifically, a part of the background image 60 that is inside the viewing filed 70 is displayed as a game screen. In other words, the viewing field 70 is a visual field of a viewpoint (virtual camera) set in the two-dimensional game space (for example, the background image 60).

The aspect ratio of the viewing field 70 corresponds to, for example, the aspect ratio of the display screen that is means for displaying the background image 60 (for example, the first liquid crystal display unit 22a or the second liquid crystal display unit 32). In the following description, the vertices of the viewing field 70 have coordinates as illustrated in FIG. 3. Specifically, an upper left vertex P₁ has coordinates (U₁, V₁), an upper right vertex P₂ has coordinates (U₂, V₂), a lower left vertex P₃ has coordinates (U₃, V₃), and a lower right vertex P₄ has coordinates (U₄, V₄), respectively.

The viewing field 70 moves, for example, to the left or the right (in the U-axis direction) to reflect a change in game situation or a slide operation (direction instructing operation) performed by the user. In a case where the viewing field 70 moves to the right, the background image 60 scrolls to the left. When the viewing field 70 moves to the left, on the other hand, the background image 60 scrolls to the right.

A direction in which the viewing field 70 moves (or a direction in which the background image 60 scrolls, for example, the U-axis direction) is hereinafter referred to as reference direction. The reference direction is, for example, the long-side direction or short-side direction of the background image 60 (the horizontal direction or the vertical direction, i.e., the U-axis direction or the V-axis direction). In other words, the reference direction is the long-side direction or short-side direction of the display means (for example, the first liquid crystal display unit 22a or the second liquid crystal display unit 32) viewed from the user.

The size of the background image 60 is larger than the size of the viewing field 70 in the reference direction as illustrated in FIG. 3. Therefore, the background image 60 scrolls when the viewing field 70 moves.

This embodiment discusses a case in which a game screen generated in the manner described above is displayed on the second liquid crystal display unit 32. The first liquid crystal display unit 22a displays a game screen on which the user makes various instructing operations.

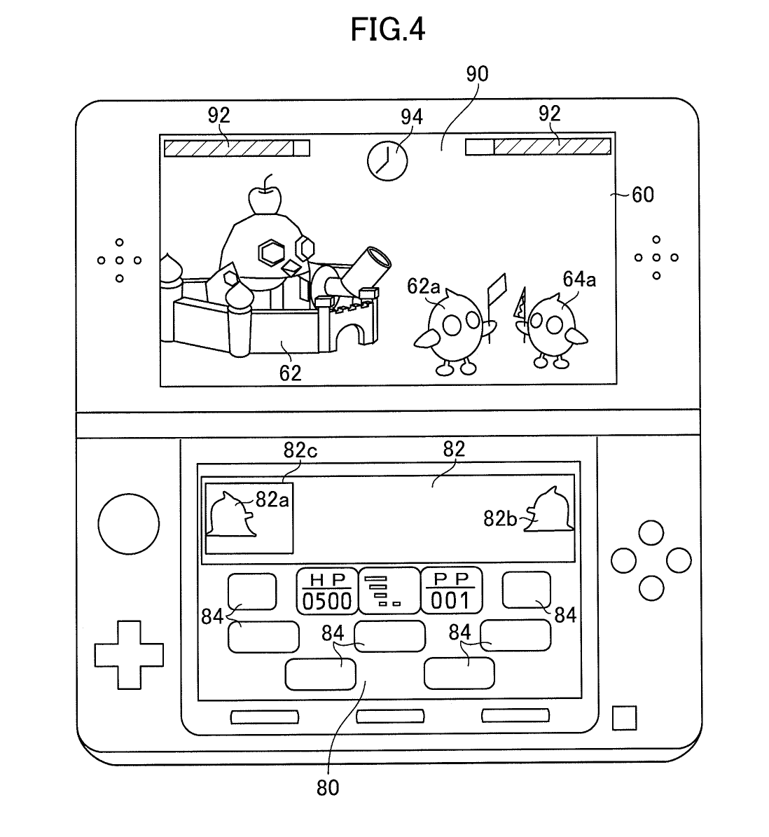

FIG. 4 is a diagram illustrating game screens that are displayed on the first liquid crystal display unit 22a and the second liquid crystal display unit 32. As illustrated in FIG. 4, the first liquid crystal display unit 22a displays a first game screen 80 and the second liquid crystal display unit 32 displays a second game screen 90.

Displayed on the first display screen 80 are, for example, an instruction area 82 with which the user instructs the viewing field 70 to move, images of icons 84 with which the user performs various game operations, and other images. This embodiment describes a case where the user performs various operations by touching an image that is displayed on the first game screen 80 with the touch pen P and sliding the image.

The instruction area 82 contains an own territory image 82a, which indicates the position of the own territory 62, an opponent territory image 82b, which indicates the position of the opponent territory 64, and a viewing field image 82c, which indicates the position of the viewing field 70. The width of the instruction area 82c corresponds to, for example, the width of the background image 60. In other words, the aspect ratio of the instruction area 82 corresponds to, for example, the aspect ratio of the background image 60 (U₀:V₀). Further, the positions of the own territory image 82a and the opponent territory image 82b in the instruction area 82 correspond respectively to the positions of the own territory 62 and the opponent territory 64 in the background image 60.

The user touches a point in the instruction area 82 with the touch pen P and slides the touch pen P, thereby causing the background image 60 to scroll on the second game screen 90. This embodiment describes a case where the viewing field 70 moves to the left or the right when the user slides the viewing field image 82c to the left or the right while continuously touching the viewing field image 82c with the touch pen P. In other words, the background image 60 on the second game screen 90 scrolls to the left or the right when the user slides the viewing field image 82c to the left or the right. The viewing field image 82c may have an aspect ratio that is the same as or differs from the aspect ratio of the viewing field 70.

The second game screen 90 contains, among others, images inside the viewing field 70 (the background image 60, the own territory 62, the fellow character 62a, and the opponent character 64a in the case of FIG. 4), gauges 92 which indicate game parameters, and a clock image 94 which indicates time within the game. The gauges 92 expand and contract as the game progresses. The displayed clock image 94 is updated in a manner that advances the hands of the clock with the elapse of time.

In this embodiment, to where the second game screen 90 scrolls (i.e., the destination of the viewing field 70) varies depending on how the touch pen P is moved when the user slides the viewing field image 82c and then breaks off the contact with the viewing field image 82c (in short, when the user releases hold of the viewing field image 82c).

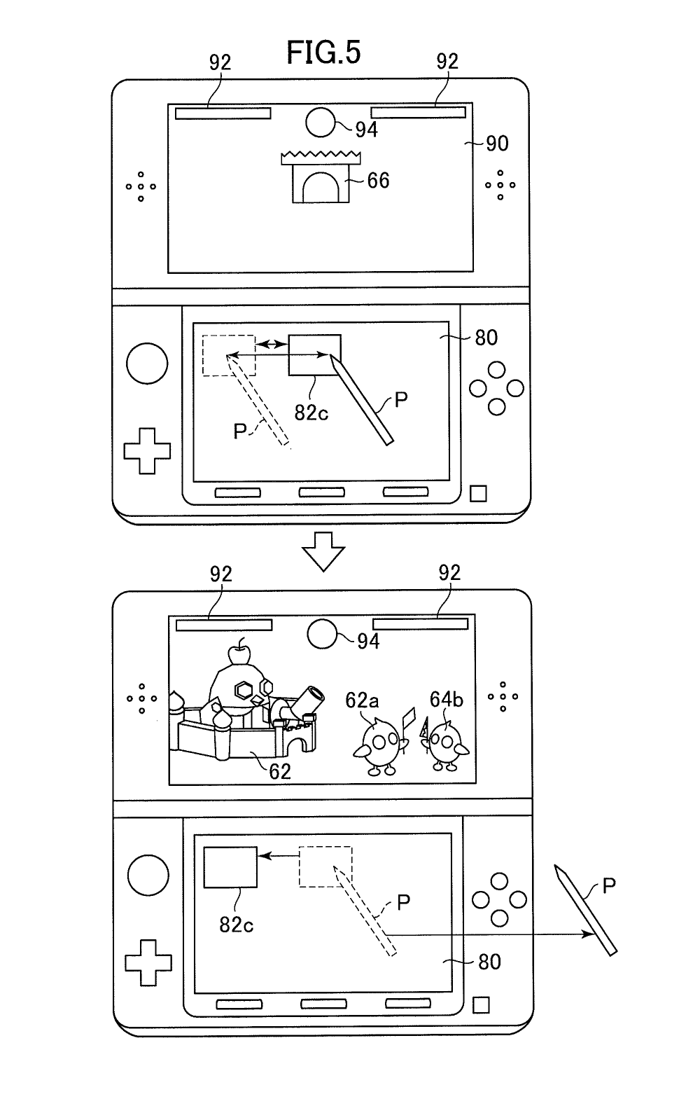

FIG. 5 is a diagram illustrating a screen transition that is executed when the user touches the viewing field image 82c to slide the viewing field image 82c to the left or the right and then releases hold of the viewing field image 82c. As illustrated in FIG. 5, the viewing field 70 moves to the left or the right when the user slides the viewing field image 82c to the left or the right while continuously touching the viewing field image 82c with the touch pen P. The second game screen 90 scrolls as the viewing field 70 moves.

When the user slides the viewing field image 82c to the left or the right and then breaks off the contact with the viewing field image 82c, the viewing field 70 returns to a reference point, and the viewing field image 82c also returns to its original display point, as illustrated in FIG. 5. This embodiment describes a case where the reference point is, for example, an initial point from which the viewing field 70 starts moving. In other words, the second game screen 90 returns to the original display (the same state as in FIG. 4) when the user breaks off the contact with the viewing field image 82c.

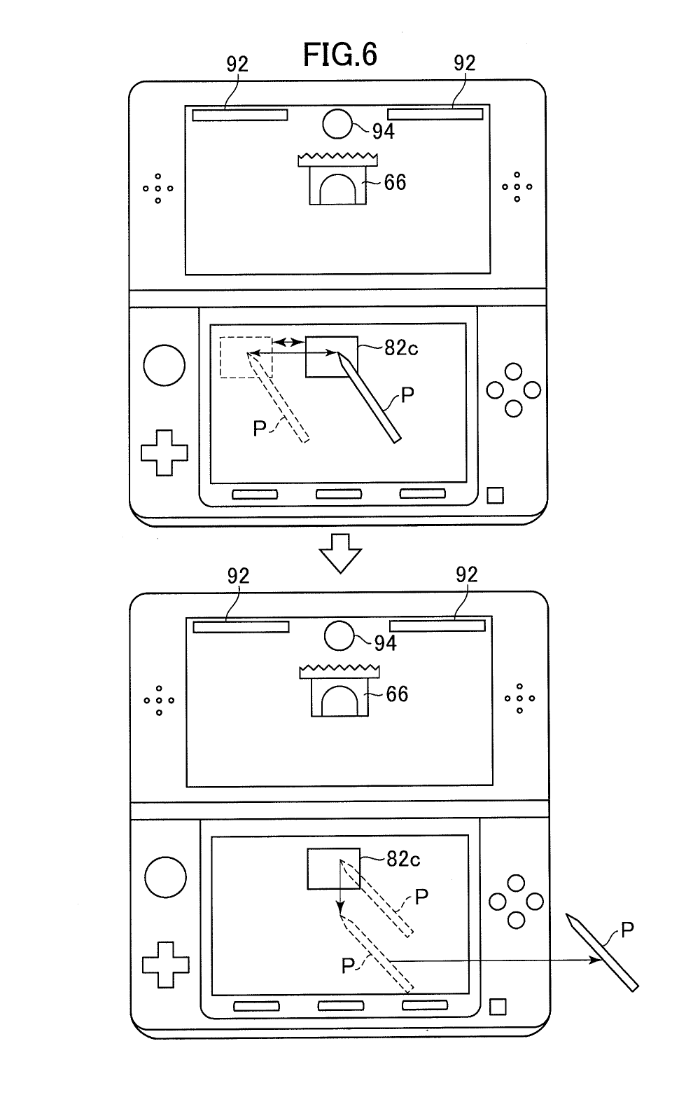

FIG. 6 is a diagram illustrating a screen transition that is executed when the user touches the viewing field image 82c to slide the viewing field image 82c to the left or the right and to subsequently slide the viewing field image 82c by a given amount in a direction that is downward from the user's viewpoint, and then releases hold of the viewing field image 82c. FIG. 6 is similar to FIG. 5 in that the viewing field 70 moves to the left or the right when the user slides the viewing field image 82c to the left or the right while keeping touching the viewing field image 82c.

When the user slides the touch pen P by a given amount in a vertically downward direction and then pulls back the touch pen P from the viewing field image 82c, the viewing field 70 is held (locked) to the current spot instead of returning to the initial point. In this case, because the viewing field 70 does not return to the initial point, pulling back the touch pen P from the viewing field image 82c does not cause the second game screen 90 to scroll.

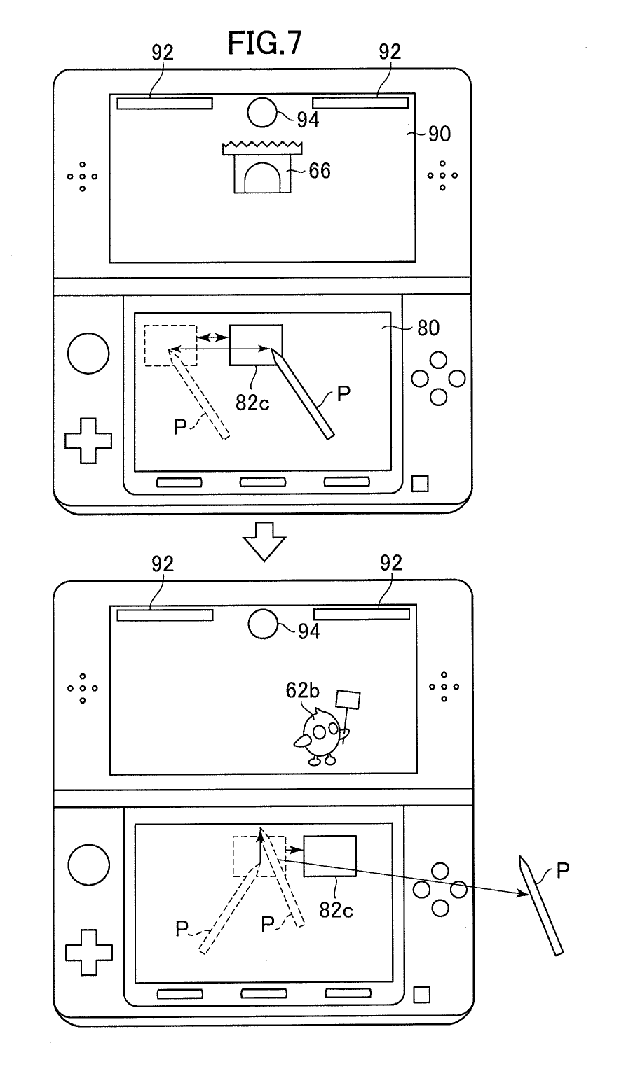

FIG. 7 is a diagram illustrating a screen transition that is executed when the user touches the viewing field image 82c to slide the viewing field image 82c to the left or the right and to subsequently slide the viewing field image 82c by a given amount in a direction that is upward from the user's viewpoint, and then releases hold of the viewing field image 82c. As illustrated in FIG. 7, when the user slides the touch pen P by a given amount in a vertically upward direction and then pulls back the touch pen P from the viewing field image 82c, the viewing field 70 moves to a spot where the viewing field 70 will contain the fellow character 62b, which is closest to the opponent territory 64, out of all fellow characters.

In this manner, in this embodiment, sliding the viewing field image 82c while continuously touching the viewing field image 82c with the touch pen P thus causes the viewing field 70 to move to the left or the right and causes the background image 60 on the second game screen 90 to scroll. The game machine 10 is configured in a manner that varies where the background image 60 on the second game screen 90 scrolls to (the destination of the viewing field 70) depending on how the user pulls back the touch pen P from the viewing field image 82c. This technology is described in detail below.

### [5. Functions Implemented in the Game Machine]

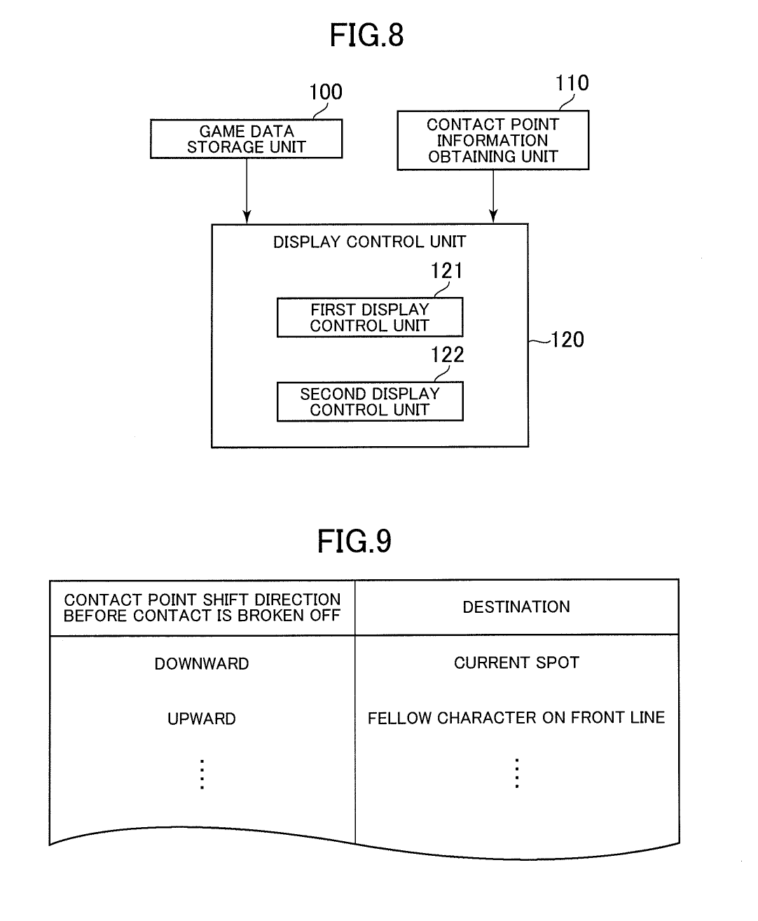

FIG. 8 is a functional block diagram illustrating functions that are relevant to the present invention out of functions implemented in the game machine 10. As illustrated in FIG. 8, the game machine 10 includes a game data storage unit 100, a contact point information obtaining unit 110, and a display control unit 120.

### [5-1. Game Data Storage Unit]

The game data storage unit 100 is implemented mainly by, for example, the main memory 48, the game memory card 40, and others. The game data storage unit 100 stores data necessary to run a game. The control unit 44 functions as means for obtaining various types of data that are stored in the game data storage unit 100.

For example, the game data storage unit 100 stores game situation data which indicates the situation of a game that is being run. Examples of data stored as the game situation data include data that indicates the position of an object image placed on the background image 60, data that indicates the position of the viewing field 70, and various game parameters relevant to the game that is being run. Stored as the data that indicates the position of the viewing field 70 are, for example, the two-dimensional coordinates of a representative vertex of the viewing field 70 (e.g., the upper left vertex P₁).

The game data storage unit 100 also stores, for example, image data necessary to display the first game screen 80 and the second game screen 90. Data stored in the game data storage unit 100 is not limited to the examples given above, and can be any data necessary to run the game.

### [5-2. Contact Point Information Obtaining Unit]

The contact point information obtaining unit 110 is implemented mainly by the touch panel 22b and the control unit 44. The contact point information obtaining unit 110 obtains contact point information which indicates a contact point on one display screen (for example, the touch screen 22). The contact point information in this embodiment is obtained based on a signal that is input from the touch panel 22b.

The control unit 44 determines that a contact with the touch panel 22b has commenced in a case where, for example, the contact point information obtaining unit 110 obtains the contact point information. Further, the control unit 44 determines that a contact with the touch panel 22b has been broken off in a case where, for example, the contact point information obtaining unit 110 stops obtaining the contact point information.

The contact point information obtained by the contact point information obtaining unit 110 maybe stored in the game data storage unit 100 in association with, for example, the time at which the information has been obtained. Associating the contact point information with the obtained time enables the control unit 44 to keep track of time-series changes in contact point. In other words, the control unit 44 can figure out a direction in which the contact point shifts.

### [5-3. Display Control Unit]

The display control unit 120 is implemented mainly by the control unit 44. The display control unit 120 displays an image on one display screen (for example, the second liquid crystal unit 32) based on the viewing field 70 which is set (disposed) in a two-dimensional image or in a virtual three-dimensional space (details thereof are described later). To give an example, the display control unit 120 controls the second liquid crystal display unit 32 to display an image that is inside the viewing field 70 set on the background image 60. Further, to give another example, the display control unit 120 controls the second liquid crystal display unit 32 to display the background image 60 by moving the viewing field 70.

The display control unit 120 includes a first display control unit 121 and a second display control unit 122.

### [First Display Control Unit]

The first display control unit 121 displays an image on one display screen (for example, the second liquid crystal display unit 32) by moving the viewing field 70 in the reference direction in a case where the contact point shift direction corresponds to the reference direction.

The contact point shift direction is, for example, a direction in which the point of contact between the touch pen P and the touch panel 22b shifts, and in which the user slides an image on the touch panel 22b with the use of the touch pen P. The contact point shift direction is determined based on data that has been obtained by the contact point information obtaining unit 110. For example, the contact point shift direction is determined based on time-series changes in contact point information.

“In a case where the contact point shift direction is parallel to the reference direction” is, for example, a case where the contact point shift direction is in the reference direction or in an opposite direction to the reference direction. This embodiment describes a case where the viewing field 70 moves to the left or the right and the background image 60 on the second game screen 90 scrolls to the left or the right in a case where the user touches the viewing field image 82c with the touch pen P to slide the viewing field image 82c to the left or the right.

### [Second Display Control Unit]

The second display control unit 122 displays an image on one display screen (for example, the second liquid crystal display unit 32) in a case where a contact with another display screen (for example, the touch screen 22) is broken off, by setting the position of the viewing field 70 based on the contact point shift direction that is observed prior to the breaking off of the contact. “In a case where a contact is broken off” is synonymous with a case where the contact point information obtaining unit 110 stops obtaining the contact point information, i.e., a case where the user pulls back the touch pen P from the touch panel 22b.

“The contact point shift direction that is observed prior to the breaking off of the contact” is the contact point shift direction between the time when the contact with the touch panel 22b is broken off and a time that precedes the breaking off of the contact by a given amount of time, and means the contact point shift direction immediately before the contact with the touch panel 22b is broken off. For example, in a case where the user slides the viewing field image 82c to the left or the right with the use of the touch pen P, subsequently slides the viewing field image 82c downward on the touch panel 22b by a given amount, and then breaks off the contact between the touch pen P and the touch panel 22b, the contact point shift direction prior to the breaking off of the contact is downward.

In this embodiment, the display control by the second display control unit 122 is executed if the amount of slide in the contact point shift direction (e.g., a vertical direction) before the contact between the touch screen 22 and the touch pen P is broken off is equal to or larger than a given amount. For example, in a case where the amount of slide in the contact point shift direction (e.g., a vertical direction) before the contact between the touch screen 22 and the touch pen P is broken off is less than the given amount, the display control by the first display control unit 121 is executed instead of the display control by the second display control unit 122.

The second display control unit 122 sets the position of the viewing field 70 to a point inside the background image 60 that is associated with, for example, the contact point shift direction that is observed prior to the breaking off of the contact. For example, the contact point shift direction that is observed prior to the breaking off of the contact and information about the destination (position) of the viewing field 70 (conditions for determining where the background image 60 scrolls to) are associated with each other in advance.

FIG. 9 is a diagram illustrating the association between the contact point shift direction that is observed prior to the breaking off of the contact and the information about the destination of the viewing field 70. Stored as the information about the destination of the viewing field 70 are information that indicates the position of the destination, information that indicates a condition for determining the destination (e.g., game situation data), information that says that the viewing field 70 is not to be moved, and the like.

In this embodiment, the viewing field 70 moves to the initial point in a case where the user slides the touch pen P in the reference direction and then breaks off the contact between the touch pen P and the touch screen 22. In a case where the user slides the touch pen P upward by a given amount and then breaks off the contact, the viewing field 70 moves to a spot where a fellow character that is closest to the opponent territory 64 of all fellow characters is located. Further, in a case where the user slides the touch pen P downward by a given amount and then breaks off the contact, the viewing field 70 is held at the spot where the contact is broken off.

In other words, in a case where the contact point shift direction prior to the breaking off of the contact is parallel to the reference direction, the second display control unit 122 moves the viewing field 70 to the initial point, which is where the moving of the viewing field 70 by the first display control unit 121 starts. The initial point is the position of the viewing field 70 at the time the moving of the viewing field 70 by the first display control unit 121 is started.

Specifically, in a case where the user pulls back the touch pen P from the viewing field image 82c, the same image that is displayed at the start of the scroll executed by the first display control unit 121 is displayed on the second liquid crystal display unit 32. For example, the viewing field 70 moves to a spot where the position of a representative vertex of the viewing field 70 coincides with the position of the representative vertex at the time the scroll executed by the first display control unit 121 is started.

The second display control unit 122 restricts the move of the viewing field 70 to the initial point in a case where the contact point shift direction prior to the breaking off of the contact does not correspond to the reference direction (or in a case where the contact point shift direction prior to the breaking off of the contact is orthogonal to the reference direction). To give an example, the second display control unit 122 determines the new position of the viewing field 70 such that an image that had been inside the viewing field 70 at the time of the breaking off of the contact is contained in the viewing field 70 at the new position. To give another example, the second display control unit 122 prevents the viewing field 70 from leaving the spot where the viewing field 70 had been at the time of the breaking off of the contact.

In other words, the second display control unit 122 restricts (prevents) the move of the viewing field 70 to the initial point in the case where the user slides the viewing field image 82c with the use of the touch pen P in the U-axis direction (rightward or leftward), subsequently slides the viewing field image 82c by a given amount in the V-axis direction (upward or downward), and then breaks off the contact between the touch pen P and the viewing field image 82c. An example of the consequence is that the background image 60 does not scroll to the initial point. The user can thus make an instinctive operation of checking the automatic move of the viewing field 70 toward the initial point and locking the viewing field 70 on the spot.

In a case where a contact with one display screen (for example, the touch screen 22) is broken off, the second display control unit 122 sets the position of the viewing field 70 based on the contact point shift direction prior to the breaking off of the contact and on the game situation data. For example, the second display control unit 122 sets the position of the viewing field 70 based on a game situation data condition that is associated with the contact point shift direction prior to the breaking off of the contact (e.g., information indicating that the destination of the moving field 70 is a spot where the fellow character that is on the front line of the attack is located), and on the game situation data.

In the case of a game where an object (e.g., a fellow character) is disposed in a two-dimensional image or in a virtual three-dimensional space as in this embodiment, the second display control unit 122 may set the position of the viewing field 70 based on the contact point shift direction prior to the breaking off of the contact and on the position of the object. For example, the second display control unit 122 sets the position of the viewing field 70 such that a fellow character located in the contact point shift direction prior to the breaking off of the contact is contained in the viewing field 70 at the new position.

This embodiment describes, as an example of the case of determining the destination of the viewing field 70 based on the game situation data, moving the game field 70 to a spot where the fellow character that is on the front line of the attack is located. However, the destination of the viewing field 70 may be determined based on other types of data stored as the game situation data.

The second display control unit 122 may also have, for example, a function of varying the condition for determining the destination of the viewing field 70 depending on the game situation data. For example, the condition for determining the destination may be varied depending on the parameters that are indicated by the gauges 92 or the time indicated by the clock image 94.

To give a concrete example, the second display control unit 122 may move the viewing field 70 based on the position of the fellow character that is on the front line of the attack in a case where a parameter value indicated by one of the gauges 92 is larger than a reference value, and move the viewing field 70 based on the position of the opponent character that is closest to the own territory 62 in a case where the parameter value indicated by the gauge 92 is equal to or smaller than the reference value. The destination of the viewing field 70 may also be the spot where the opponent territory 64 is located or the spot where the fort 66 is located.

### [6. Processing Executed in the Game Machine]

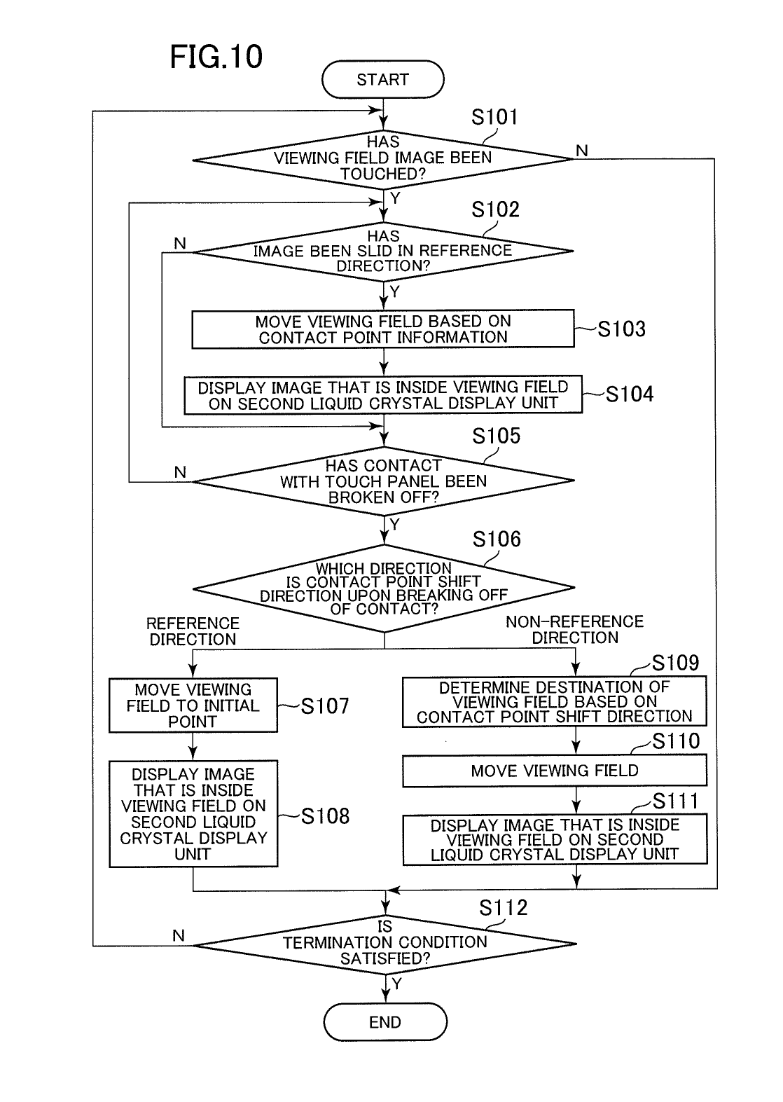

Processing executed in the game machine 10 is described next. FIG. 10 is a flow chart illustrating processing that is executed by the game machine 10 after a game is started. The control unit 44 executes the processing of FIG. 10 by following a program that is stored in the game memory card 40.

As illustrated in FIG. 10, the control unit 44 first determines whether or not the viewing field image 82c has been touched (S101). In the case where the viewing field image 82c has not been touched (S101: N), the processing proceeds to S112.

In the case where the viewing field image 82c has been touched (S101: Y), the control unit 44 determines whether or not the viewing field image 82c has been slid in the reference direction (S102). In other words, the control unit 44 determines in S102 whether or not a direction in which the point of contact with the viewing field image 82c shifts corresponds to the reference direction.

In the case where the viewing field image 82c has not been slid in the reference direction (S102: N), the processing proceeds to S105. In other words, the processing proceeds to S105 in the case where the viewing field image 82c has been slid in other directions than the reference direction, in the case where the contact with the viewing field image 82c has been broken off, or in the case where the contact with the viewing field image 82c is maintained at the same contact point.

In the case where the viewing field image 82c has been slid in the reference direction (S102: Y), the control unit 44 moves the viewing field 70 based on the contact point information (S103). The viewing field 70 is moved, for example, to a spot where the contact point inside the instruction area 82 and the position of the viewing field 70 inside the background image 60 correspond to each other. In other words, the viewing field 70 moves in a direction in which the point of contact with the viewing field image 82c has shifted. As the viewing field 70 moves, the viewing field image 82c also shifts its position.

The control unit 44 controls the second liquid crystal display unit 32 to display an image that is inside the viewing field 70 moved in S103 (S104). In other words, the background image 60 scrolls to the corresponding part, which is now displayed on the second liquid crystal display unit 32.

The control unit 44 determines whether or not the contact with the touch panel 22b has been broken off (S105). In the case where the contact with the touch panel 22b has not been broken off (S105: N), the processing returns to S102.

In the case where the contact with the touch panel 22b has been broken off (S105: Y), the control unit 44 determines the contact point shift direction at the time of the breaking off of the contact with the touch panel 22b (S106). The contact point shift direction obtained in S106 is the direction of shift observed between the time when the contact point information is no longer obtained and the time that precedes the cessation of the contact point information by a given amount of time.

In the case where the contact point shift direction at the time of the breaking off of the contact coincides with the reference direction (S106: reference direction), the control unit 44 moves the viewing field 70 to the initial point (S107). In other words, the viewing field 70 returns to the initial point in the case where the contact point shift direction immediately before the breaking off of the contact does not indicate a given amount of slide in other directions than the reference direction. For example, the viewing field 70 returns to the initial point when the contact point does not shift from the point where the touch screen 22 has been touched immediately before the breaking off of the contact (when the user just releases hold of the viewing field image 82c and does nothing else to the viewing field image 82c), or when the contact point shift direction immediately before the breaking off of the contact is the reference direction.

The control unit 44 controls the second liquid crystal display unit 32 to display an image that is inside the viewing field 70 moved in S107 (S108). In other words, what is displayed on the second game screen 90 returns to the part of the image that had been displayed before the image was scrolled in S104. The second game screen 90 in this case may display the whole process of scrolling the background image 60, or may switch to the next scene to be displayed instead of scrolling the background image 60.

In the case where the contact point shift direction prior to the breaking off of the contact does not coincide with the reference direction (S106: non-reference direction), on the other hand, the control unit 44 determines the destination of the viewing field 70 based on the contact point shift direction (S109). In other words, when it is determined in S106 that the touch pen P has been slid by a given amount in other directions than the reference direction at the time of the breaking off of the contact with the touch screen 22, a destination condition that is associated with the contact point shift direction in question is referred to in S109.

The control unit 44 moves the viewing field 70 to the destination determined in S109 (S110). To give an example, in the case where the contact point shift direction at the time of the breaking off of the contact is downward, the viewing field 70 is held at the current spot. To give another example, in the case where the contact point shift direction at the time of the breaking off of the contact is upward, game situation data is referred to in order to move the viewing field 70 to a spot where the viewing field 70 will contain the fellow character that is on the front line of the attack.

The control unit 44 controls the second liquid crystal display unit 32 to display an image that is inside the viewing field 70 moved in S110 (S111). In S111, the second liquid crystal display unit 32 may display the whole process of scrolling the background image 60, or may switch to the next scene to be displayed instead of scrolling the background image 60.

The control unit 44 determines whether or not a termination condition is satisfied (S112). The termination condition is a condition determined in advance. Examples of the termination condition include a condition for screen transition and whether or not an operation instructing to end the game has been performed.

In the case where the termination condition is satisfied (S112: Y), this processing is ended. In the case where the termination condition is not satisfied (S112: N), the processing returns to S101.

According to the game machine 10 described above, the user can move the viewing field 70 to the left or the right by touching the viewing field image 82c with the touch pen P and sliding the viewing field image 82c to the left or the right. In a case where the user releases hold of the viewing field image 82c, the viewing field 70 moves to a destination that varies depending on how the viewing field image 82c is released. This allows the user to determine the destination of the viewing field 70 according to the user's preference, and thus improves user friendliness. In addition, a game situation is taken into account in the decision on the destination of the viewing field 70, which improves the operability of the game.

The present invention is not limited to the embodiment described above, and can be modified suitably without departing from the spirit of the present invention.

(1) For example, while the embodiment has described a case where the viewing field 70 moves in a two-dimensional image, the viewing field 70 may move in a virtual three-dimensional space. In this case, the game machine 10 displays on one display screen an image of a game space (virtual three-dimensional space) that is viewed from a given viewpoint.

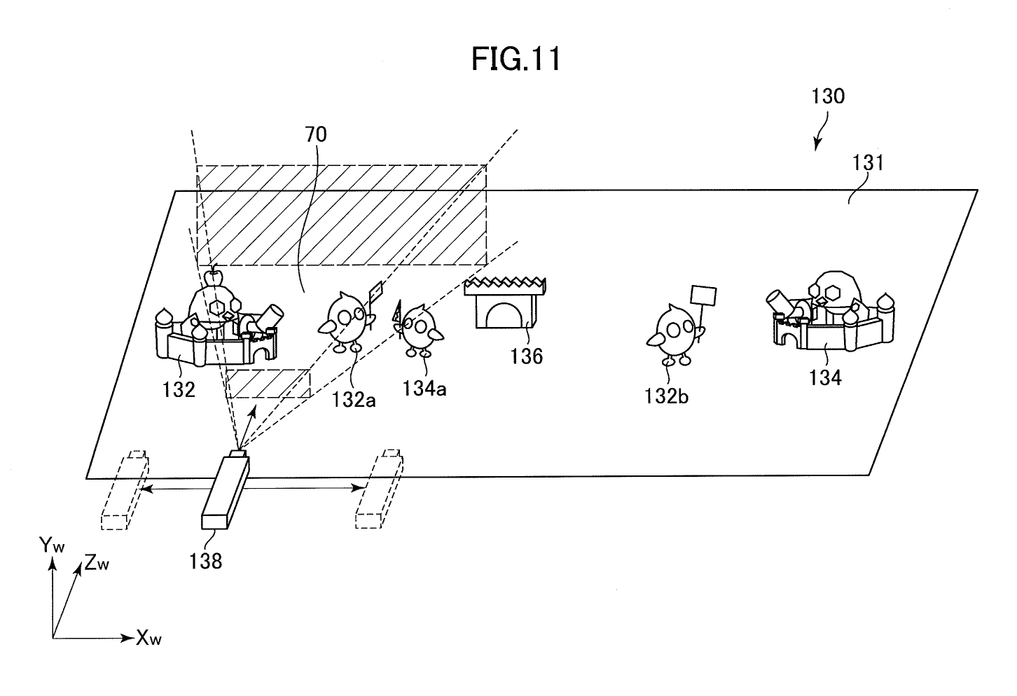

FIG. 11 is a diagram illustrating a game space in Modification Example (1). As illustrated in FIG. 11, a field object 131 is disposed in a game space 130. Objects disposed on the field object 131 include an own territory object 132, which corresponds to the own territory 62, fellow character objects 132a an 132b, which correspond to the fellow characters 62a and 62b, an opponent territory object 134, which corresponds to the opponent territory 64, an opponent character object 134a, which corresponds to the opponent character 64a, and a fort object 136, which corresponds to the fort 66.

A virtual camera (viewpoint) 138 is also set in the game space 130. The viewing field 70 that corresponds to the virtual camera 138 is set in the game space 130. The viewing field 70 in Modification Example (1) is an area (view frustum) cut out of the visual field of the virtual camera 138 on a near clipping plane 138a and a far clipping plane 138b. The visual field of the virtual camera 138 is specified based on the position, sight line direction, and viewing angle of the virtual camera 138.

The second game screen 90 displays an object that is inside the viewing field 70. For example, the three-dimensional coordinates (world coordinates) of each object are converted into two-dimensional coordinates (screen coordinates) by known coordinate transformation processing, and an object that is contained in the viewing field 70 corresponding to the virtual camera 138 is displayed on one display screen of the game machine 10 through the coordinate transformation.

Information about the objects disposed in the game space 130 and the virtual camera 138 (for example, position, moving direction, and sight line direction) is stored in the game data storage unit 100. This information has values that are varied to suit the game program or the user's operation.

In Modification Example (1), the display control unit 120 moves the viewing field 70 of FIG. 11 in the reference direction. The reference direction in Modification Example (1) can be any direction set within the game space 130. The reference direction in the example of FIG. 11 is an Xw-axis direction. As in the embodiment, the second game screen 90 scrolls as an operation of sliding the viewing field image 82c which is performed by the user moves the viewing field 70.

As in the embodiment, the destination of the viewing field 70 (namely, the virtual camera 138) varies depending on the contact point shift direction before the user breaks off the contact with the touch panel 22b. To give an example, in a case where the user slides the viewing field image 82c to the left or the right and then breaks off the contact, the viewing field 70 returns to the initial point. To give another example, in a case where the user slides the viewing field image 82c to the left or the right, subsequently slides the viewing field image 82c downward by a given amount, and then breaks off the contact, the viewing field 70 is held at the current spot. To give still another example, in a case where the user slides the viewing field image 82c to the left or the right, subsequently slides the viewing field image 82c upward by a given amount, and then breaks off the contact, the viewing field 70 moves to a spot where the fellow character object 132b will be contained in the viewing field 70.

According to Modification Example (1), the user-friendliness of a game that is run based on a virtual three-dimensional space is improved.

(2) While the embodiment describes a case where the second display control unit 122 moves the viewing field 70 to the initial point, the second display control unit 122 may move the viewing field 70 to a predetermined reference point. For example, the destination of the viewing field 70 may be determined based on the position of the viewing field 70 at the time the contact with the viewing field image 82c is broken off.

In Modification Example (2), a plurality of reference points are defined in advance in a two-dimensional image or in a virtual three-dimensional space. For example, a plurality of reference points are set at regular intervals in the reference direction (e.g., the U-axis direction or the Xw-axis direction) of the the background image 60 or the game space 130. Described here is a case of setting a plurality of reference points in the background image 60. The interval between the reference points and the length in the reference direction of the viewing field 70 (for example, the distance between the upper left vertex P₁ and the upper right vertex P₂) may be substantially the same.

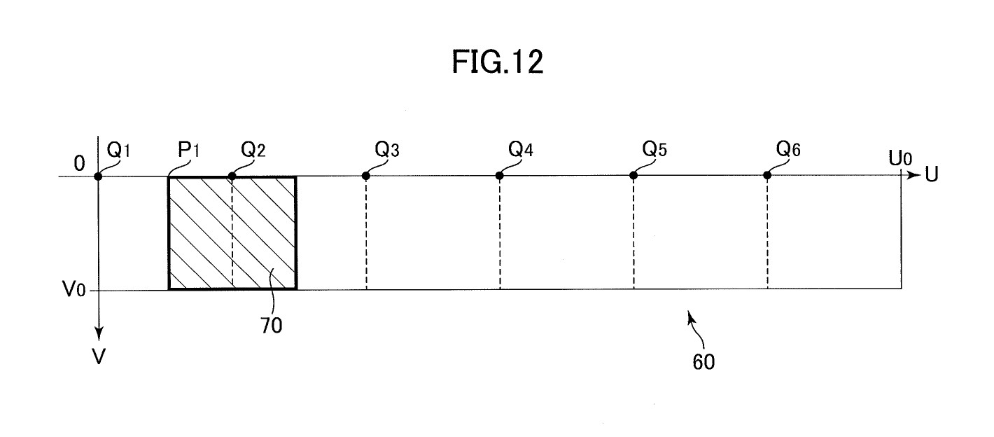

FIG. 12 is a diagram illustrating reference points in Modification Example (2). As illustrated in FIG. 12, six reference points (reference point Q₁ to reference point Q₆), for example, are set in the background image 60. The interval between these reference points is substantially equal to the width of the viewing field 70. In other words, if the breadth of the viewing field 70 is expressed as one page, the background image 60 of FIG. 12 has six pages of images arranged side by side in the reference direction.

In the case where the contact point shift direction before the contact is broken off corresponds to the reference direction, the second display control unit 122 moves the viewing field 70 based on the positional relation between the position of the viewing field 70 at the time of the breaking off of the contact and the plurality of reference points. For example, the second display control unit 122 determines the destination of the viewing field 70 based on the reference point closest to the representative vertex of the viewing field 70 at the time of the breaking off of the contact.

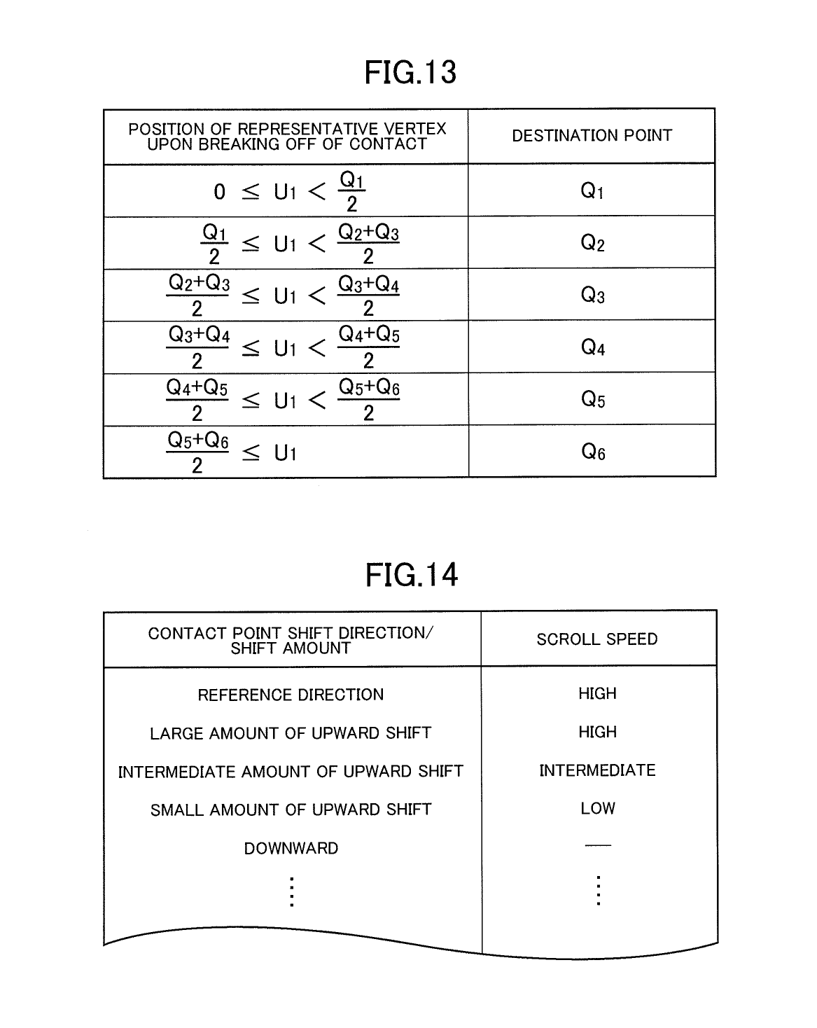

FIG. 13 is a diagram illustrating the relation between the position of the representative vertex of the viewing field 70 at the time of the breaking off of the contact and a destination point of the viewing field 70. For example, in a case where the representative vertex of the viewing field 70 is the upper left vertex P₁ as illustrated in FIG. 13, the viewing field 70 moves to a spot where the upper left vertex P₁ coincides with one of the reference points Q₁ to Q₆ that is closest to the position of the upper left vertex P₁ at the time of the breaking off of the contact. In other words, the viewing field 70 moves to a spot where one page ends and another page begins so that one whole page out of the pages of the background image 60 is contained within the screen.

In the case where the contact point shift direction before the contact is broken off does not correspond to the reference direction, the second display control unit 122 of Modification Example (2) restricts the move of the viewing field 70 that is based on the positional relation between the position of the viewing field 70 at the time of the breaking off of the contact and the plurality of reference points. For example, the second display control unit 122 prevents the viewing field 70 from leaving the spot where the viewing field 70 has been at the time of the breaking off of the contact.

Specifically, the second display control unit 122 in this case stops the processing of moving the representative vertex of the viewing field 70 to one of the reference points and holds the viewing field 70 at the current spot. Alternatively, in a case where the contact point shift direction prior to the breaking off of the contact does not correspond to the reference direction, the second display control unit 122 of Modification Example (2) may move the viewing field 70 to another spot inside the background image 60 (the spot where the fellow character on the front line of the attack is located, the last page, or the like) as in the embodiment.

According to Modification Example (2), in a case where scrolling a menu screen over a plurality of pages, the user can choose from: letting the menu screen automatically scroll to a spot between pages; holding the menu screen at the spot where the menu screen had been at the time of the breaking off of the contact with the touch panel 22b; and letting the menu screen scroll to a spot preferred by the user.

Modification Example (1) and Modification Example (2) maybe combined with each other. In other words, a plurality of reference points may be set in a virtual three-dimensional space. In this case, the destination of the virtual camera 138 is determined based on the positional relation between the position of the virtual camera 183 at the time of the breaking off of the contact and the plurality of reference points.

(3) In a case where the game machine 10 scrolls one display screen based on the move of the viewing field 70, the scroll speed may vary depending on how the user releases hold of the viewing field image 82c. In other words, the moving speed of the viewing field 70 may vary depending on how the user releases hold of the viewing field image 82c.

The second display control unit 122 determines the scroll speed of the display screen based on the contact point shift direction and/or shift amount before the contact with the viewing field image 82c is broken off. The second display control unit 122 uses the determined scroll speed as, for example, a basis in moving the viewing field 70. The contact point shift amount is the amount of shift in contact point that is observed between the time when the contact with the viewing field image 82c is broken off and the time that precedes the breaking off of the contact by a given amount of time.

FIG. 14 is a diagram illustrating the relation between a contact point shift direction and/or shift amount prior to the breaking off of the contact and a moving speed of the viewing field 70. As illustrated in FIG. 14, the scroll speed is high in a case where the contact point shift direction at the time of the breaking off of the contact is in the reference direction. The scroll speed is also higher in a case where, for example, the contact point shift amount is larger.

According to Modification Example (3), the game machine 10 determines the moving speed of the viewing field 70 based on the user's operation, and is therefore improved in user-friendliness.

(4) While the reference direction in the embodiment and modification examples described above is in the left-right direction of the background image 60, the reference direction can be any predetermined direction. For example, the reference direction may be an up-down direction or an oblique direction in the background image 60. Similarly, the reference direction can be any direction in the game space 130.

(5) While the embodiment and modification examples described above deal with a case where the game machine 10 includes two display units, only one display unit may be included in the game machine 10. In other words, the game machine 10 does not always need to include the second liquid crystal display unit 32.

The game machine 10 in this case is equipped with a touch panel that is overlaid on the one display unit. The background image 60 is displayed on this display unit. The user touches the background image 60 with the touch pen P or a fingertip to slide the background image 60 itself and thereby move the viewing field 70. In another example, the game machine 10 includes three or more display units.

(6) While the descriptions given above deal with cases where the information processing device according to the present invention is applied to a game machine, the information processing device according to the present invention is applicable to any device that displays an image on a display screen based on a viewing field set in a two-dimensional image or in a virtual three-dimensional space.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An information processing device, which displays an image on a display screen based on a viewing field set in a two-dimensional image or a virtual three-dimensional space, comprising:
contact point information obtaining means for obtaining contact point information which indicates a point of contact with the display screen;
first display control means for displaying the image on the display screen by moving the viewing field in a reference direction in a case where a contact point shift direction corresponds to the reference direction; and
second display control means for displaying the image on the display screen after the contact with the display screen is broken off, by setting a position of the viewing field based on the contact point shift direction that is observed prior to the breaking off of the contact.

2. The information processing device according to claim 1, wherein the second display control means is configured to:
in a case where the contact point shift direction prior to the breaking off of the contact corresponds to the reference direction, move the viewing field to an initial point, which is where the moving of the viewing field by the first display control means starts; and
in a case where the contact point shift direction prior to the breaking off of the contact does not correspond to the reference direction, restrict the move of the viewing field to the initial point.

3. The information processing device according to claim 1,
wherein the two-dimensional image or the virtual three-dimensional space comprises a plurality of reference points which are defined in advance, and
wherein the second display control means is configured to:
in a case where the contact point shift direction prior to the breaking off of the contact corresponds to the reference direction, move the viewing field based on a positional relation between the position of the viewing field prior to the breaking off of the contact and the plurality of reference points; and
in a case where the contact point shift direction prior to the breaking off of the contact does not correspond to the reference direction, restrict the move of the viewing field based on the positional relation.

4. The information processing device according to claim 1, further comprising means for scrolling the display screen based on the move of the viewing field,
wherein the second display control means comprises means for determining a scroll speed of the display screen based on at least one of the contact point shift direction and shift amount prior to the breaking off of the contact.

5. The information processing device according to claim 1, further comprising:
means for running a game; and
means for obtaining game situation data which indicates a situation of the game,
wherein the second display control means sets the position of the viewing field after the contact with the display screen is broken off, based on the contact point shift direction prior to the breaking off of the contact and on the game situation data.

6. A method of controlling an information processing device, which displays an image on a display screen based on a viewing field set in a two-dimensional image or a virtual three-dimensional space, comprising:
a contact point information obtaining step of obtaining contact point information which indicates a point of contact with the display screen;
a first display control step of displaying the image on the display screen by moving the viewing field in a reference direction in a case where a contact point shift direction corresponds to the reference direction; and
a second display control step of displaying the image on the display screen after the contact with the display screen is broken off, by setting a position of the viewing field based on the contact point shift direction that is observed prior to the breaking off of the contact.

7. A non-transitory computer readable information storage medium having recorded thereon a program for causing a computer to function as an information processing device, which displays an image on a display screen based on a viewing field set in a two-dimensional image or a virtual three-dimensional space, the information processing device comprising:
contact point information obtaining means for obtaining contact point information which indicates a point of contact with the display screen;
first display control means for displaying the image on the display screen by moving the viewing field in a reference direction in a case where a contact point shift direction is parallel to the reference direction; and
second display control means for displaying the image on the display screen after the contact with the display screen is broken off, by setting a position of the viewing field based on the contact point shift direction that is observed prior to the breaking off of the contact.
